(19) United States
(12) Patent Application Publication
(10) Pub. No.: US 2014/0168328 A1
(43) Pub. Date: Jun. 19, 2014

(54) NON-SPHERICAL PARTICLE SEPARATOR FOR INK JET PRINTER

(71) Applicant: PALO ALTO RESEARCH CENTER INCORPORATED, Palo Alto, CA (US)

(72) Inventor: John S. Paschkewitz, San Carlos, CA (US)

(73) Assignee: Palo Alto Research Center Incorporated, Palo Alto, CA (US)

(21) Appl. No.: 13/719,174

(22) Filed: Dec. 18, 2012

(51) Int. Cl. B41J 2/175

(52) U.S. Cl. CPC B41J 2/17563
USPC 347/93

(57) ABSTRACT

A device is disposed within an ink flow channel of an ink jet printer and is arranged to remove particles from ink. The device includes an alignment region that aligns non-spherical particles along their major dimension in the ink flow channel. A guiding region is arranged to direct the non-spherical particles towards a first streamline region of the ink flow channel and away from a second streamline region of the ink flow channel. During operation of the ink jet printer, particle-rich ink flows in the first streamline region and particle-free ink flows in the second streamline region. A splitting region arranged downstream from the guiding region splits the ink flow channel into first and second branches. The first channel branch is arranged to carry the particle-rich ink and the second channel branch is arranged to carry the particle-free ink.

### TECHNICAL FIELD

This application relates generally to techniques that involve the use of particle separators in ink jet printers. The application also relates to components, devices, systems, and methods pertaining to such techniques.

### BACKGROUND

Ink jet printers operate by ejecting small droplets of liquid ink onto print media according to a predetermined pattern. In some implementations, the ink is ejected directly on a final print media, such as paper. In some implementations, the ink is ejected on an intermediate print media, e.g. a print drum, and is then transferred from the intermediate print media to the final print media. Some ink jet printers use cartridges of liquid ink to supply the ink jets. Solid ink printers have the capability of using a phase change ink which is solid at room temperature and is melted before being jetted onto the print media surface. Inks that are solid at room temperature advantageously allow the ink to be transported and loaded into the ink jet printer in solid form, without the packaging or cartridges typically used for liquid inks. In some implementations, the solid ink is melted in a page-width print head which jets the molten ink in a page-width pattern onto an intermediate drum. The pattern on the intermediate drum is transferred onto paper through a pressure nip.

In the liquid state, ink may contain particles that can obstruct the passages of the ink jet pathways. Particles in the ink may be introduced into the ink when they flake off of materials used to form the ink flow path, or may result from contamination that is not removed from waste ink recycled back into the print head.

### SUMMARY

Embodiments discussed in the disclosure are directed to approaches for removing particles from ink in an ink jet printer.

Some embodiments are directed to a device for removing particles from ink in an ink flow channel of an ink jet printer. The device includes a hyperbolic contraction of the ink flow channel. A guiding region disposed in the ink flow channel downstream from the hyperbolic contraction includes one or more obstacles that extend across a width of ink flow channel. The obstacles are arranged to direct particles away from a first streamline region of the ink flow channel that is arranged to carry particle-free ink and towards a second streamline region of the ink flow channel that is arranged to carry particle-rich ink, the particle-rich ink including more particles than the particle-free ink. A splitting region is arranged downstream from the guiding region. The splitting region is configured to split the ink flow channel into first and second channel branches, the first channel branch arranged to carry the particle-rich ink flowing in first streamline region and the second channel branch arranged to carry the particle-rich ink flowing in the second streamline.

According to some aspects, the hyperbolic contraction of the ink flow channel comprises two opposing hyperbolic shaped walls. With reference to a Cartesian coordinate system having orthogonal x, y, z axes, the hyperbolic contraction comprises:

an input having a width, w_{c-i}, of about 400 μm along the y axis;

an output having a width, w_{c-o}, of about 40 μm to about 140 μm along the y axis;

a length, L_{c}, between the input and the output along the x direction of about 30 μm to about 130 μm; and

a height, H_{c}, of about 100 μm to about 250 μm along the z axis.

The hyperbolic contraction may be dimensioned so that total Hencky strain, ε_{H}=ln(w_{c-i}/w_{c-o}), of the hyperbolic contraction is between about 1 and about 2.

In some implementations w_{c-o} is less than or equal to a length of the particles. The length of the particles may be about 40 μm, for example.

According to some implementations, the one or more obstacles may be at least two obstacles. With reference to a Cartesian coordinate system having orthogonal x, y, z axes, an ink flow direction in the ink flow channel is along the x axis, the width of the ink flow channel is along the y axis, a height of the ink flow channel is along the z axis:

a center-to-center distance between two obstacles along the x axis is about 50 μm; and/or

a center-to-center distance between two obstacles along the height of the ink flow channel is about 50 μm; and/or

the obstacles have cross sectional dimensions in the x-z plane of about 25 μm×25 μm.

In some configurations, the particle remover further includes a rotation region configured to induce rotation of non-spherical particles. For example, the rotation region is disposed between the contraction and the guiding obstacles and may include one or more undulations along a wall of the ink flow channel.

Some embodiments relate to a device disposed within an ink flow channel of an ink jet printer and arranged to remove particles from ink. The device includes an alignment region configured to align non-spherical particles along their major dimension in the ink flow channel. A guiding region is disposed in the ink flow channel downstream from the alignment region. The guiding region is arranged to direct particles towards a first streamline region of the ink flow channel and away from a second streamline region of the ink flow channel. During operation of the ink jet printer, particle-rich ink flows in the first streamline region and particle-free ink flows in the second streamline region. A splitting region is arranged downstream from the guiding region. The splitting region splits the ink flow channel into first and second channel branches. The first channel branch is arranged to carry the particle-rich ink that flows in the first streamline region and the second channel branch is arranged to carry the particle-free ink that flows in the second streamline region.

In some cases, a rotation region is disposed in the ink flow channel between the alignment region and the guiding region, the rotation region including features configured to induce rotation of the non-spherical particles.

The ink flow channel may be formed as a multilayer stack.

With reference to a Cartesian coordinate system having orthogonal x, y, z axes, an ink flow direction in the ink flow channel is along the x axis, the width of the ink flow channel is along the y axis, a height of the ink flow channel is along the z axis:
the height of the ink flow channel at an output of the alignment region may be configured to allow rotation of the non-spherical particles in the x-z plane; and/or
the width of the ink flow channel between the output of the alignment region and one more guiding features in the guiding region may be configured to inhibit rotation of the non-spherical particles in the x-y plane; and/or
the width of the ink flow channel in the guiding region may be configured to less than a major dimension of the non-spherical particles.

Some embodiments involve a method for removing non-spherical particles from ink in an inkjet printer. Non-spherical particles are aligned along their major dimension as the particles flow through an ink flow channel. The aligned non-spherical particles are guided toward a first streamline region that carries particle-rich ink and away from a second streamline region that carries particle-free ink. The particle-rich ink is directed along a first branch of the ink flow channel and the particle-free ink is directed along a second branch of the ink flow channel.

The non-spherical particles have a minor dimension, Pₘᵢₙ, and a major dimension, Pₘₐⱼ, and the aligned non-spherical particles are rotated in the x-z plane prior to guiding the aligned non-spherical particles. The rotation causes the non-spherical particles to approach a guiding region with an effective diameter, P_{eff}, where Pₘᵢₙ≦P_{eff}≦Pₘₐⱼ.

According to some embodiments, a device for removing non-spherical particles from ink in an ink jet printer includes means for aligning the non-spherical particles along their major dimension as the particles flow through an ink flow channel. The device includes means for guiding the aligned non-spherical particles toward a first streamline region that carries particle-rich ink and away from a second streamline region that carries particle-free ink. A means for directing directs the particle-rich ink along a first branch of the ink flow channel and directs the particle-free ink along a second branch of the ink flow channel.

The non-spherical particles have a minor dimension, Pₘᵢₙ, and a major dimension, Pₘₐⱼ. The device further includes means for rotating the aligned non-spherical particles in the x-z plane disposed between the means for aligning and the means for guiding, the means for rotating causing the non-spherical particles to encounter the means for guiding with an effective diameter, P_{eff}, where Pₘᵢₙ≦P_{eff}≦Pₘₐⱼ.

### DESCRIPTION OF THE DRAWINGS

FIGS. 1A and 1B provide internal views of portions of an ink jet printer that incorporates a particle removal device;

FIGS. 2A and 2B show views of an exemplary print head;

FIG. 3 shows a possible location for the particle removal device within the ink flow channel of an ink jet printer print head;

FIG. 4A illustrates an x-y plane cross sectional view of a particle separator in accordance with embodiments described herein;

FIG. 4B is an x-z cross sectional view of the particle separator of FIG. 4A;

FIG. 4C is an x-z cross sectional view of a particle separator that includes rotation features in accordance with some embodiments;

FIG. 4D is an x-z cross sectional view of a particle separator that includes optional additional obstacles in the guiding region in accordance with some embodiments.

FIG. 5 diagrammatically illustrates a possible flow path of a particle as it traverses the rotation and guiding regions of a particle separator in accordance with some embodiments;

FIG. 6 shows the layered structure of some particle separators discussed herein; and

FIG. 7 is a flow diagram illustrating a method of separating particles from ink in an ink jet printer.

Like reference numbers refer to like components; and

Drawings are not necessarily to scale unless otherwise indicated.

### DESCRIPTION OF VARIOUS EMBODIMENTS

Particles in the ink jet pathways can cause misplaced, intermittent, missing or weak ink jetting resulting in undesirable visual flaws in the final printed pattern. Some ink jet printers pass the ink through filters to prevent particles from reaching the jet region of the print head. However, these techniques present several problems. Filtering is non-optimal because filters can become clogged over the operational life of the printer. Significant engineering is required to ensure that coalesced particles do not clog the filter. Additionally, filter elements block the ink flow to some extent and induce a pressure drop penalty that may be undesirable in print head operation. This pressure drop is exacerbated as the filter surface becomes covered with particles that have been filtered from the ink. It is better to remove the particles to a separate trapping feature using features that dynamically separate particles from the primary ink flow path. An additional problem with simple sieves typically used in inkjet printers is that they are vulnerable to particles that are not spherical. Particles with a small dimension less than the pore size of the sieve can align and pass through the sieve holes and subsequently clog the ink jets.

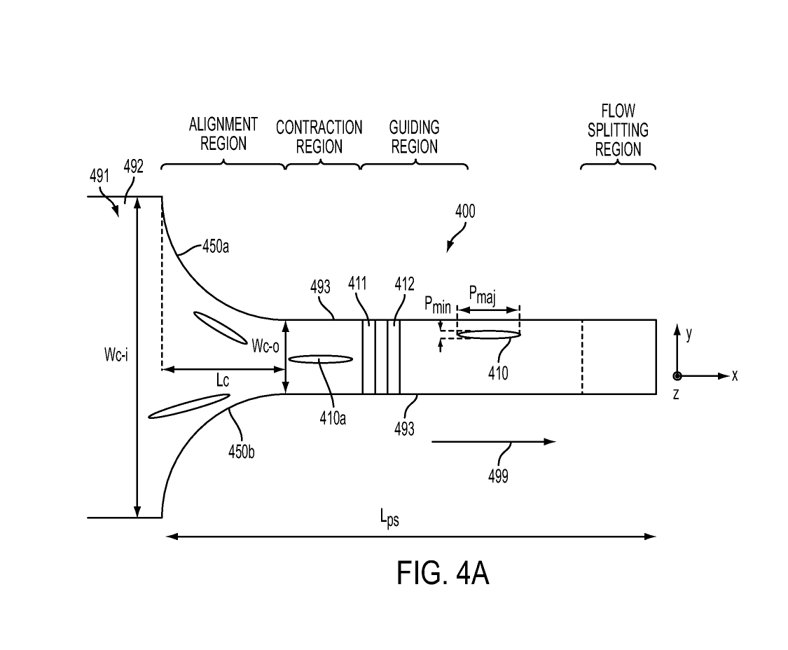

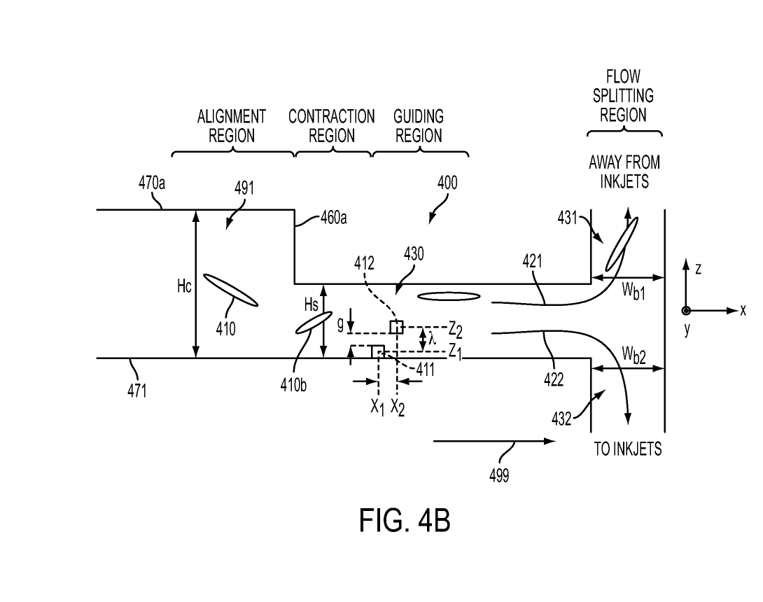

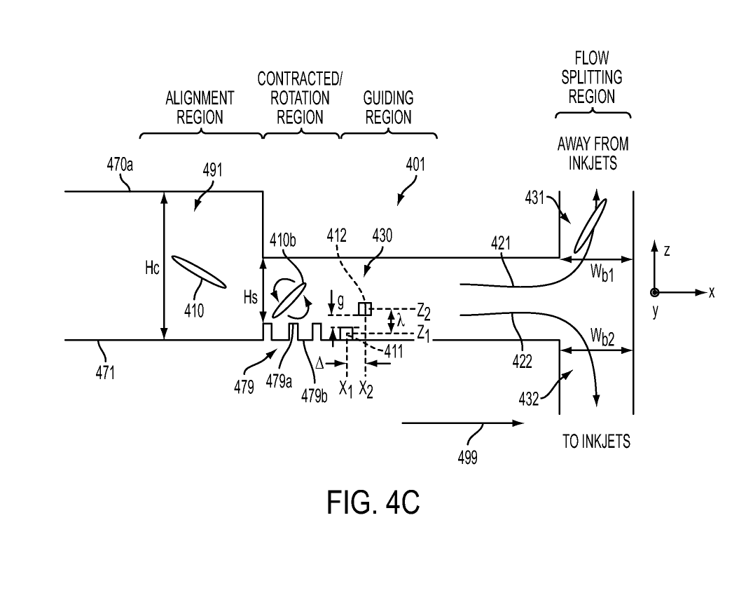

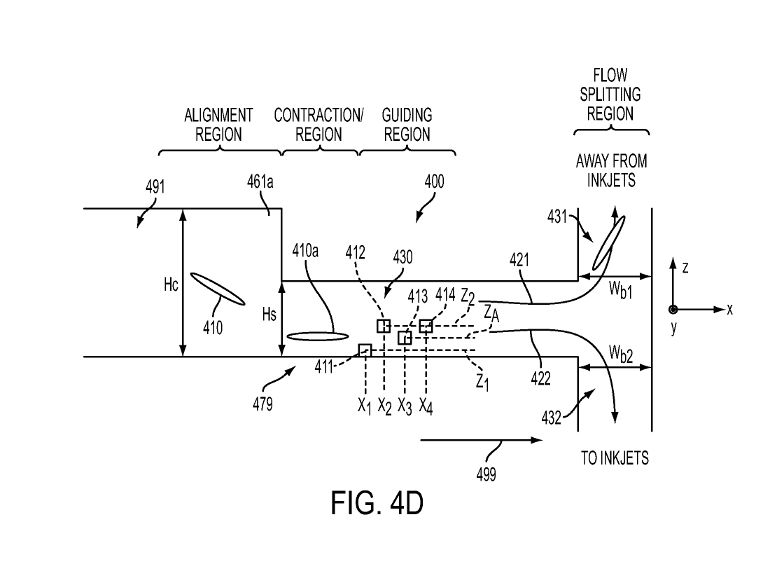

Embodiments described in this disclosure involve approaches for removing particles from the ink of an ink jet printer prior to jetting the ink onto a print medium. In particular, elongated particles which may be fiber threads or solidified ink, for example, can be problematic. Elongated, non-spherical particles can be characterized as having a minor dimension, Pₘᵢₙ and a major dimension, Pₘₐⱼ as illustrated by particle 410 in FIG. 4A. Embodiments described herein provide low-pressure approaches to remove non-spherical particles with simple geometric features from the ink flow path of an ink jet printer. For example, some approaches discussed below involve a particle separator for an ink jet printer that uses an alignment region to induce alignment of non-spherical particles in the direction of the ink flow, a guiding region positioned downstream of the alignment region, the guiding region configured to constrain the rotation of the non-spherical particles to a single axis and to direct and/or entrain the non-spherical particles along a streamline that carries particle-rich ink. The particle separator includes a flow splitting region positioned downstream of the guiding region that carries the particle-rich ink away from the ink jets. In some implementations, the particle separator includes a rotation region positioned between the alignment region and the guiding region to induce rotation of the particles as they approach the guiding region.

In some examples, the alignment region comprises a contraction, e.g., hyperbolic contraction of the ink flow channel. The contraction in some examples is used in conjunction with a guiding region that comprises an obstacle array configured to direct the non-spherical particles toward a first streamline region of the flow channel and away from a second streamline region of the flow channel. During operation, the particles are directed along the first streamline of particle-rich ink. The second streamline contains particle-free ink. The obstacles are arranged between the hyperbolic contraction and a T or Y-shaped branching of the ink flow channel in the flow splitting region. In the flow splitting region, the ink flow channel splits into first and second sub-branches. The branches are arranged so that the particle-rich ink flowing along a first streamline region of the flow channel enters a first sub-branch whereas the substantially particle-free ink flowing along the second streamline region of the flow channel enters a second sub-branch. The first sub-branch carries the particle-rich ink flowing along the first streamline away from the ink jet, e.g., towards a particle trap, and the second sub-branch carries the particle-free ink that flows along the second streamline toward the ink jet. Examples of a particle separator for non-spherical particles that involves an alignment region, a guiding region, an optional rotation region, and/or a flow splitting region are described below in the context of a hyperbolic contraction (alignment region) disposed upstream of an obstacle arrangement (guiding region) which is disposed upstream of a flow splitting region (T or Y channel branching feature). Those skilled in the art will appreciate that the specific features discussed herein (hyperbolic contraction, obstacle arrangement, and branching feature) are exemplary only and the particle alignment, guiding, and flow splitting approaches discussed herein can be extended to other types of features that provide the functionality of non-spherical particle alignment, guiding, and flow splitting.

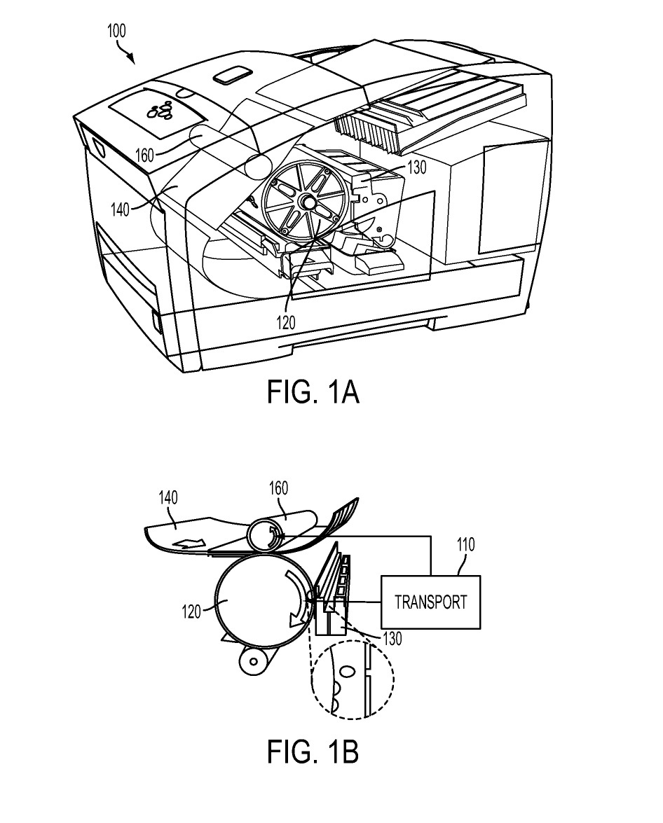

FIGS. 1A and 1B provide internal views of portions of an exemplary ink jet printer 100 that incorporates a non-spherical particle separator as discussed herein. The printer 100 includes a transport mechanism 110 that is configured to move the drum 120 relative to the print head 130 and to move the paper 140 relative to the drum 120. The print head 130 may extend fully or partially along the length of the drum 120 and includes a number of ink jets. As the drum 120 is rotated by the transport mechanism 110, ink jets of the print head 130 deposit droplets of ink though ink jet apertures onto the drum 120 in the desired pattern as illustrated the inset circle in FIG. 1B. As the paper 140 travels over the drum 120, the pattern of ink on the drum 120 is transferred to the paper 140 through a pressure nip 160.

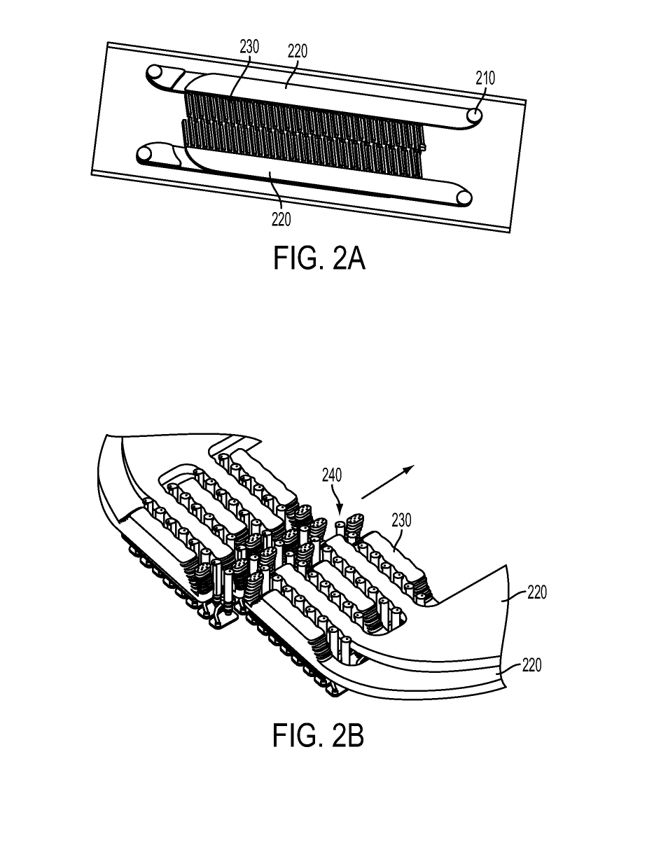

FIGS. 2A and 2B provide more detailed views of an exemplary print head. The path of molten ink, contained initially in a reservoir, flows through a port 210 into a main manifold 220 of the print head. As best seen in FIG. 2B, in some cases, there are four main manifolds 220 which are overlaid, one manifold 220 per ink color, and each of these manifolds 220 connects to interwoven finger manifolds 230. The ink passes through the finger manifolds 230 and then into the ink jets 240. The manifold and ink jet geometry illustrated in FIG. 2B is repeated in the direction of the arrow to achieve a desired print head length, e.g. the full width of the drum. It will be appreciated that the specific configurations of the ink jet printer 100 and print head illustrated in FIGS. 1-2 are provided as examples, and that ink jet printers and/or ink jet print heads have a variety of configurations applicable to the particle separators discussed herein.

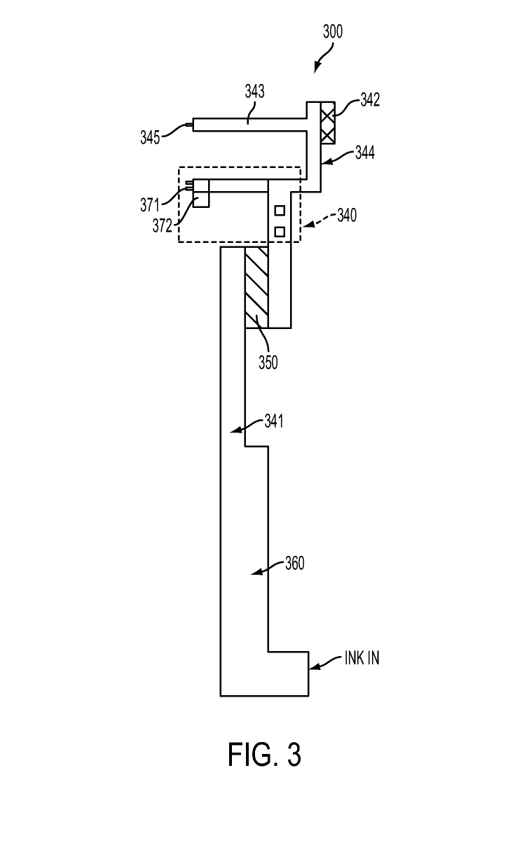

Each ink jet includes an actuator that controls the ejection of the ink drops through the ink jet nozzle onto the print medium, e.g., the drum. In some implementations, the print head uses piezoelectric transducers (PZTs) for ink droplet ejection, although other methods of ink droplet ejection are known and such printers may also use particle separators as described herein. FIG. 3 provides a cross sectional view of a print head showing a main manifold, 360, a finger manifold 341 and ink jet 300. Activation of the PZT 342 causes a pumping action that alternatively draws ink into the jet inlet 344 and expels the ink through ink jet nozzle 343 via an aperture 345. The particle separator 340 discussed herein includes features that interact with particles in the ink and can be used to control the flow paths of particles of various sizes. Most particles above a critical diameter can be diverted to a particle vent 371 and/or particle trap 372 allowing “clean” ink that does not substantially include particles having diameters above the critical diameter to flow into the jet inlet 344.

FIG. 3 indicates a possible location for the particle separator 340 in the finger manifold 341. For example, in various configurations, the particle separator 340 may be located in the print head manifold upstream of an ink jet 300. In some implementations, ink jet printers use a sieving element in the ink path such as a “rock screen” that is located upstream of the ink jets. The sieving element can employ a single layer of material with cutouts smaller than the jet aperture diameter. Non-spherical particles with a diameter smaller than these apertures can penetrate the sieving element and cause jet clogging. A particle separator as discussed herein may be located in the print head along the ink flow path downstream of the sieving element 350 (between the sieving element 350 and the ink jet inlet 344) to mitigate or prevent jet clogging. The guiding features of the particle separator 340, e.g., bumps, notches, or bars, in a passage of the print head are likely to cause modest pressure drop compared to the alternative of much smaller holes in the rock screen or a multi-layer rock screen. The print head may include multiple particle separators positioned at one or more locations, e.g., in one or more or each of the ink jet inlets.

FIGS. 4A and 4B illustrate x-y and x-z cross sections, respectively, of a particle separator 400 in accordance with some configurations. In some orientations, the cross section of FIG. 4A may be referred to as a top view and the cross section of FIG. 4B may be referred to as a side view, and although other orientations are possible, this convention is used to discuss the particle separator features. The particle separator 400 comprises an alignment region (e.g., hyperbolic contraction) a guiding region (e.g., obstacle arrangement) and a flow splitter (e.g., T branch) disposed within an ink flow channel 491. Ink 492 is contained within the ink flow channel 491 by one or more flow channel walls 493 and flows along the flow channel 491 in the direction indicated by arrow 499. The ink 492 is contaminated with non-spherical particles 410 which may have various shapes including elongated, non-spherical, rod-like and/or fiber-shaped particles 410. The particle separators described herein are particularly useful to align, guide and separate fibers and other non-spherical particles from the clean ink that flows to the jets. As shown in FIG. 4A, such non-spherical particles 410 may be characterized by a major dimension, Pₘₐⱼ, and a minor dimension, Pₘᵢₙ, where Pₘₐⱼ>Pₘᵢₙ. Pₘₐⱼ may be referred to as the length of a particle and Pₘᵢₙ may be referred to as the diameter of the particle.

As illustrated in FIGS. 4A and 4B the particles 410 enter the particle separator at a hyperbolic contraction of the flow channel formed by at least one channel wall that hyperbolically narrows the flow channel. The top view of FIG. 4A shows a hyperbolic contraction formed by opposing hyperbolic channel wall portions 450a, 450b that bound the flow channel 491 in the x-y plane. In some embodiments the hyperbolic contraction may be formed by a hyperbolic channel wall on one side of the flow channel and a straight wall (or a wall having a shape other than hyperbolic) on the opposing side of the flow channel. A channel wall is considered to be hyperbolic if the curvature of the channel wall can be approximated by an equation of the form y=1/x. In some embodiments, the channel wall is approximated by y=C/(a+x), where C and a are constants that depend on the geometry of the contraction. As shown in FIGS. 4A and 4B, the width of the contraction along the y axis at the input of the contraction is W_{c-i}, the width of the contraction along the y axis at the output of the contraction is W_{c-o}, and the length of the contraction along the x axis is L_{c}. Suitable parameters for a contraction that effectively aligns particles having major dimension, Pₘₐⱼ in a range between about 30 to about 50 μm may be, for example, W_{c-i} equal to about 400 μm, L_{c} in a range of about 30 to about 130 μm, W_{c-o} in a range of about 140 to about 40 μm, input height of the contraction, H_{c}, of about 100 to about 250 μm, output height of the contraction, Hₛ, of about 100 μm. The overall length of the particle separator, Lₚₛ, may be about 500-1000 μm, for example. The Hencky strain is the logarithmic strain experienced by a fluid element in the contraction and can be expressed ε_{H}=ln(W_{c-i}/W_{c-o}) which can be in a range of about 1 to about 2. the hyperbolic contraction comprises:

In some embodiments, the width of the flow channel at the output of the contraction W_{c-o} is selected to be sufficiently narrow to restrict rotation of the particles in the x-y plane. causing the particles to be substantially aligned along the x axis in the x-y plane as indicated by the particle 410a shown in FIG. 4A. The height of the flow channel at the output of the contraction, Hₛ, is selected to be sufficiently large to allow rotation of the particles in the x-z plane, as indicated by the rotated particle 410b shown in FIG. 4B. Note that the orientation of the elongated particles in the x-z plane determines the effective size of the particles, P_{eff}, which is presented to the obstacles (Pₘᵢₙ≦P_{eff}≦Pₘₐⱼ).

The guiding features (obstacles) may comprise bars extending across flow channel along the y axis and may have a variety of cross-sectional shapes. In some cases, the obstacles can be oriented substantially perpendicular to the ink flow direction 499. The arrangement of obstacles 411, 412 is designed to divert particles 410 having Pₘₐⱼ greater than a critical diameter, D_{c}, along a first trajectory 421 (i.e., along a first streamline region) and allow the flow of ink that does not contain particles 410 (or contains fewer particles) having Pₘₐⱼ>D_{c} along a second trajectory 422 (i.e., along a second streamline region). The obstacles 411, 412 are arranged so that the relatively “dirty” ink which contains non-spherical particles 410 having Pₘₐⱼ>D_{c} flows along the first streamline 421 and the “clean” ink flows along the second streamline 422.

To effectively separate particles having a Pₘₐⱼ in the range of about 30 to about 50 μm, some designs use obstacles having a cross sectional area of about 25×25 μm. In other words, with reference to FIG. 4B, in cross section, the obstacles may extend a distance Dₓ of about 25 μm along the x axis and/or may extend a distance D_{z} of about 25 μm along the z axis. However, the obstacles need not have a square cross section. For example, in some cases, the obstacles may be rectangular in cross section, e.g., the z axis dimension of the obstacles may be greater than the x axis dimension or vice versa. The arrangement of obstacles can, in some cases, include only one obstacle, and may include more than one obstacle as illustrated by FIGS. 4A-4C. When more than one obstacle is included in the arrangement, as illustrated by the two obstacles 411, 412 that are shown in FIGS. 4A and 4B, the arrangement of the obstacles 411, 412 may be described in terms of an array. Note that in some cases the array may include more than two obstacles.

The rows of the array are arranged along the x axis such that a first row is offset from the next row by an offset distance Δ. With reference to FIG. 4B, the first row includes obstacle 411 at location x₁ along the x axis and the second row includes obstacle 412 at location x₂ along the x axis, where x₂−x₁=Δ. In other words, Δ is the center-to-center distance between obstacles in adjacent rows. The columns of the array are arranged along the z axis such that the first column includes obstacle 411 at location z₁ along the z axis and the second row includes obstacle 412 at location z₂ along the z axis, where z₂−z₁=λ which is the center-to-center distance between obstacles in adjacent columns. If the dimension of the obstacles along the z axis is D_{z} and the dimension of the obstacles along the x axis is Dₓ, then the gap, g, between the two obstacles 411, 412 in adjacent rows is g=λ−D_{z}. The critical diameter D_{c} (which corresponds to the minimum Pₘₐⱼ that the arrangement of obstacles is designed to divert into the streamline of particle-rich ink) can be expressed as Dc=1.4 g(λ/Δ)^{-0.48}. For example, according to this equation, an arrangement of obstacles designed to separate particles having Pₘₐⱼ of about 40 μm using obstacles having a 25×25 μm cross section, may have λ=50 μm and Δ=50 μm. If a particle has a diameter less than a critical diameter, D_{c}, the particle may follow a zigzag path through the arrangement of obstacles and/or may follow either of the first or second streamlines.

After traveling through the arrangement of obstacles 411, 412, the ink flowing in a first streamline 421 includes relatively more of the non-spherical particles that have Pₘₐⱼ>D_{c} when compared to any particles that may be present in the second streamline 422. For example, the first streamline may include a majority (more than 50%) may include a substantial majority (more than 75%) or may include most (90% or more) of the elongated particles that have Pₘₐⱼ>D_{c}. A flow splitter region is positioned downstream of the ink flow direction from the obstacles and is configured to split the flow in the main branch 430 of the flow channel into two sub-branches 431, 432. The two sub-branches shown in FIG. 4B form a T connection with the main branch 430 in this example. In some cases, the two sub-branches and the main branch may be arranged in a Y configuration or other configurations. As illustrated in FIG. 4B, the particle-rich ink traveling along the first streamline 421 is swept into the first sub-branch 431 and the relatively clean, particle-free ink traveling along the second streamline 422 s swept into the second sub-branch. The first sub-branch may direct the particle-rich ink away from the ink jet, e.g., toward a particle trap or waste receptacle, for example. The second sub-branch 422 directs the particle-free ink towards the ink jet. In some configurations, the width, W_{b1}, of the first sub-branch 421 may be different from the width, W_{b2}, of the second sub-branch 422. For example, in some cases, the second sub-branch may have a width that is less than Pₘₐⱼ, such that the second sub-branch is too small to ingest the non-spherical particles.

In some circumstances, particles which have not rotated sufficiently in the x-z plane may present a sufficiently small P_{eff} to the obstacle array enabling the particles to thread through the obstacles instead of being guided by them into the first streamline. In these cases, it can be helpful to include a rotation region in the particle separator between the alignment region and the guiding region. The rotation region may include features that encourage rotation of the non-spherical particles in the x-z plane (as indicated by particle 410a of FIG. 4C) so that the particles can be more effectively guided by the obstacle array. An illustrative particle separator 401 that includes a rotation region is illustrated in FIG. 4C, which is similar is some respects to FIG. 4B. The particle separator 401 of FIG. 4C differs from the particle separator 400 of FIG. 4B in that particle separator 401 includes a rotation region comprising undulations disposed along at least one flow channel wall, preferably the “bottom” wall according to the orientation of FIG. 4C (the channel wall closest to the obstacles). Each undulation comprises a valley and a peak that protrudes into the ink flow channel. About five to six undulations are arranged along the ink flow direction 499. The undulations may comprise square peaks and square valleys as shown in FIG. 4C, or the peaks and/or the valleys of the undulations may be rounded. The undulations cause the ink flow in the rotation region to have some “vertical” component (along the z direction), thus causing the particles to experience a more non-uniform velocity profile along their length. The particles may be at least the particle length deep (e.g., about 30 to about 100 μm) and twice as long (e.g., about 60 to about 300 μm).

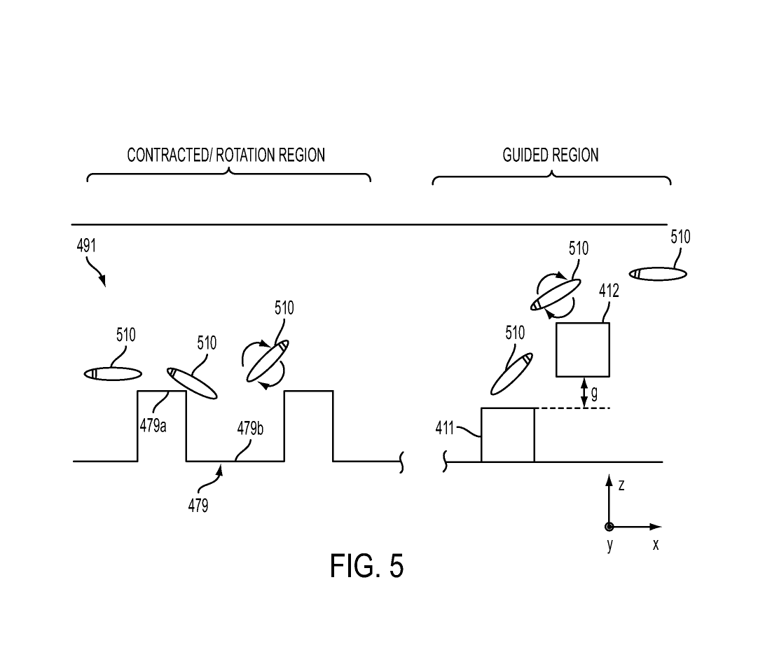

FIG. 5 illustrates portions of a contraction/rotation region and a guiding region of a particle separator disposed in an ink flow channel 491. As illustrated in FIG. 5, the dimensions of the peaks 479a and valleys 479b of the undulations 479 are selected to promote rotation of a particle 510 as the particle 510 travels over the undulations 479. FIG. 5 illustrates a particle 510 at six positions along the rotation and guiding sections of a flow channel 491. At position 1 of FIG. 5, particle 510 has exited the alignment section and is aligned in the x-z and x-y planes as the particle 510 approaches a peak 479a of an undulation. At position 2, the front end of particle 510 dips into the valley 479b of the undulation 479. Dipping into the valley 479b causes particle 510 to rotate in the x-z plane as shown at position 3. Particle 510 may encounter additional undulations as it flows through the ink flow channel to the guiding region. The rotation of particle 510 initiated in the rotation section causes the particle 510 to approach the obstacles 411, 412 rotated in the x-z plane and substantially aligned in the x-y plane at position 4. Because the particle is rotated in the x-z plane, it approaches the obstacles 411, 412 with an effective diameter, P_{eff}, that is larger than the gap, g. Thus, the encounter with the obstacles 411, 412, causes the particle 510 to rotate again as indicated at position 5. The obstacles guide the particle 510 into a streamline of particle-rich ink at position 6. The depiction provided in FIG. 5 represents one possible flow path that could be taken as the particle traverses the rotation and guiding sections of the ink flow channel. It will be appreciated that there are a multiplicity of possible flow paths that a particle could take as it travels through the ink flow channel that would guide the particle into the streamline of particle-rich ink.

FIG. 4D illustrates yet another configuration for a particle separator 402. The particle separator 402 shown in FIG. 4D is similar is some respects to the particle separator of FIG. 4B. The particle separator 402 of FIG. 4D differs from FIG. 4B at least in that the particle separator 402 includes additional obstacles 413, 414 disposed at locations (x₃, z₃) and (x₄, z_{A}) in the guiding region of the ink flow channel 491. The additional obstacles can be arranged to reduce the possibility of particles threading through the obstacle array rather than being guided by it into the streamline that carries particle-rich ink. For example, particles may thread through the obstacle array when the effective diameter, P_{eff}, presented to the obstacle array is less than the gap, g. In the example shown in FIG. 4D, additional obstacles 413, 414 are disposed downstream from obstacles 411, 412. Obstacle 413 is positioned along the z axis between obstacles 411, 412, which blocks particles that would thread through the gap between obstacle 411 and obstacle 412. For example, in some implementations, z_{A} is centered between z1 and z2, particles 412 and 414 are aligned along the z axis, and x₃−x₂ and x₄−x₃=x₂−x₁.

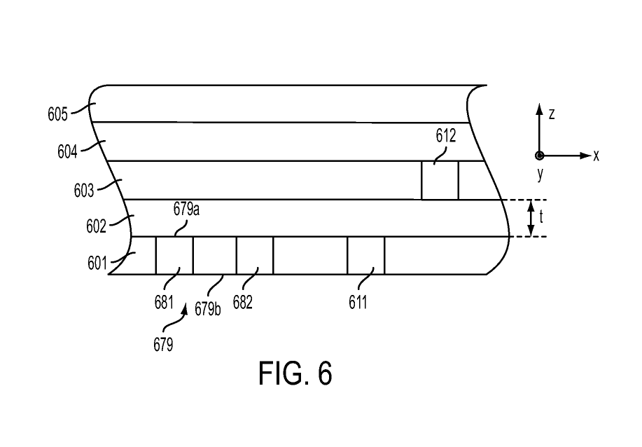

The separators discussed herein may be manufactured multiple layer structures. In some cases, the particle separators may be constructed as a laminate of several planes or layers of material. FIG. 6 shows a portion of the particle separator that includes a rotation section comprising rotation features 681, 682 the form the peaks 679a and valleys 679b of the undulations 679. The portion of the particle separator also includes a guiding section comprising guiding obstacles 611, 612. The rotation features 681, 682, and obstacles 611, 612 can be formed by a stack of material layers 601-605. For example, the rotation features 681, 682 may comprise notches, bumps, or bars extending along the y direction at the “bottom” of the flow channel. The guiding features can also be notches, bumps, or bars. As illustrated in FIG. 6, layer 601 is shaped to form the rotation features 681, 682 and the obstacle 611. Layer 603 is shaped to form obstacle 612. The rotation and guiding features 681, 682, 611, 612 are amenable to fabrication using layered print head manufacturing techniques. For example, in some implementations, the layers 601-605 may have a thickness, t, of about 25 to about 150 μm of material. The layers 601-605 may be made of any suitable material, such as metal or plastic by methods such as laser cutting, punching, machining, etching, deposition, molding, and/or printing. The layers can be attached together by any suitable method, e.g., any combination of laminating, diffusion bonding, plasma bonding, adhesives, welding, chemical bonding, and mechanical joining.

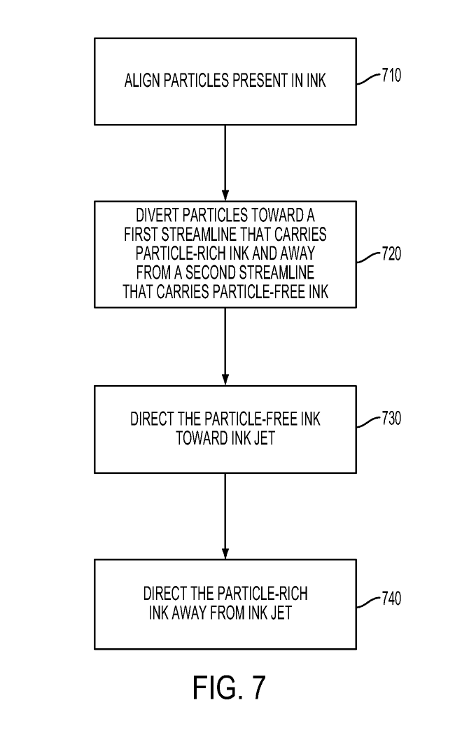

FIG. 7 is a flow diagram illustrating a particle separation method in accordance with embodiments discussed herein. Non-spherical particles are aligned 710 and constrained so that their major dimension is oriented along the direction of the ink flow. The particles are diverted 720 toward and along a first streamline in the ink flow channel. In some implementations, the particles may encounter rotation feature that induce x-z rotation of the particles after alignment and before the encountering guiding feature that divert the particles toward the first streamline. The first streamline carries particle-rich ink and away from a second streamline in the ink flow channel that carries particle-free ink. The particle free ink is directed 730 toward the ink jet and the particle-rich ink is directed 740 away from the ink jet. The particle-rich ink may be routed to a waste port and/or dump chamber and/or may be subjected to additional particle removal processes.

Systems, devices or methods disclosed herein may include one or more of the features, structures, methods, or combinations thereof described herein. For example, a device or method may be implemented to include one or more of the features and/or processes described below. It is intended that such device or method need not include all of the features and/or processes described herein, but may be implemented to include selected features and/or processes that provide useful structures and/or functionality.

Various modifications and additions can be made to the preferred embodiments discussed above. Accordingly, the scope of the present disclosure should not be limited by the particular embodiments described above, but should be defined only by the claims set forth below and equivalents thereof.

What is claimed is:

1. A device for removing particles from ink in an ink flow channel of an ink jet printer, comprising:
a hyperbolic contraction of the ink flow channel;
a guiding region disposed in the ink flow channel downstream from the hyperbolic contraction and including one or more obstacles that extend at least partially across a width of ink flow channel, obstacles arranged to direct particles toward a first streamline region arranged to carry particle-rich ink and away from a second streamline region arranged to carry particle-free ink that includes fewer particles than the particle-rich ink; and
a splitting region arranged downstream from the guiding region, the splitting region configured to split the ink flow channel into first and second channel branches, the first channel branch arranged to carry the particle-rich ink and the second channel branch arranged to carry the particle-free ink.

2. The device of claim 1, wherein the hyperbolic contraction of the ink flow channel comprises two opposing hyperbolic shaped walls.

3. The device of claim 1, wherein, with reference to a Cartesian coordinate system having orthogonal x, y, z axes, the hyperbolic contraction comprises:
an input having a width, w_{c-i}, of about 400 μm along the y axis;
an output having a width, w_{c-o}, of about 40 μm to about 140 μm along the y axis;
a length, L_{c}, between the input and the output along the x direction of about 30 μm to about 130 μm; and
a height, H_{c}, of about 100 μm to about 250 μm along the z axis.

4. The device of claim 3, wherein the hyperbolic contraction is configured so that total Hencky strain, ε_{H}=ln(w_{c-i}/w_{c-o}), of the hyperbolic contraction is between about 1 and about 2.

5. The device of claim 3, wherein w_{c-o} is less than or equal to a length of the particles.

6. The device of claim 5, wherein a length of the particles is about 40 μm.

7. The device of claim 1, wherein the one or more obstacles comprises at least two obstacles.

8. The device of claim 7, wherein, with reference to a Cartesian coordinate system having orthogonal x, y, z axes, an ink flow direction in the ink flow channel is along the x axis, the width of the ink flow channel is along the y axis, a height of the ink flow channel is along the z axis, and a center-to-center distance between two obstacles along the x axis is about 50 μm.

9. The device of claim 7, wherein, with reference to a Cartesian coordinate system having orthogonal x, y, z axes, an ink flow direction in the ink flow channel is along the x axis, the width of the ink flow channel is along the y axis, a height of the ink flow channel is along the z axis, and a center-to-center distance between two obstacles along the height of the ink flow channel is about 50 μm.

10. The device of claim 7, wherein, with reference to a Cartesian coordinate system having orthogonal x, y, z axes, an ink flow direction in the ink flow channel is along the x axis, the width of the ink flow channel is along the y axis, a height of the ink flow channel is along the z axis, the obstacles have cross sectional dimensions in the x-z plane of about 25 μm×25 μm.

11. The device of claim 1, further comprising a rotation region configured to induce rotation of non-spherical particles.

12. The device of claim 11, wherein the rotation region comprises one or more undulations along a wall of the ink flow channel.

13. A device disposed within an ink flow channel of an ink jet printer, comprising:
an alignment region configured to align non-spherical particles along their major dimension in the ink flow channel;
a guiding region disposed in the ink flow channel downstream from the alignment region, the guiding region arranged to direct particles towards a first streamline region of the ink flow channel and away from a second streamline region of the ink flow channel, wherein during operation of the ink jet printer, particle-rich ink flows in first streamline region and particle-free ink flows in the second streamline region; and
a splitting region arranged downstream from the guiding region, the splitting region arranged to split the ink flow channel into first and second channel branches, the first channel branch arranged to carry the particle-rich ink that flows in the first streamline region and the second channel branch arranged to carry the particle-free ink that flows in the second streamline region.

14. The device of claim 13, further comprising a rotation region disposed in the ink flow channel between the alignment region and the guiding region, the rotation region including features configured to induce rotation of the non-spherical particles.

15. The device of claim 14, wherein the ink flow channel comprises a multilayer stack.

16. The device of claim 13, wherein, with reference to a Cartesian coordinate system having orthogonal x, y, z axes, an ink flow direction in the ink flow channel is along the x axis, the width of the ink flow channel is along the y axis, a height of the ink flow channel is along the z axis, the height of the ink flow channel at an output of the alignment region is configured to allow rotation of the non-spherical particles in the x-z plane.

17. The device of claim 13, wherein, with reference to a Cartesian coordinate system having orthogonal x, y, z axes, an ink flow direction in the ink flow channel is along the x axis, the width of the ink flow channel is along the y axis, a height of the ink flow channel is along the z axis, the width of the ink flow channel between the output of the alignment region and one more guiding features in the guiding region is configured to inhibit rotation of the non-spherical particles in the x-y plane.

18. The device of claim 13, wherein, with reference to a Cartesian coordinate system having orthogonal x, y, z axes, an ink flow direction in the ink flow channel is along the x axis, the width of the ink flow channel is along the y axis, a height of the ink flow channel is along the z axis, the width of the ink flow channel in the guiding region is configured to less than a major dimension of the non-spherical particles.

19. A method for removing non-spherical particles from ink in an inkjet printer, comprising:
aligning the non-spherical particles along their major dimension as the particles flow through an ink flow channel;
guiding the aligned non-spherical particles toward a first streamline that carries particle-rich ink and away from a second streamline that carries particle-free ink; and
directing the particle-rich ink along a first branch of the ink flow channel and directing the particle-free ink along a second branch of the ink flow channel.

20. The method of claim 19, wherein the non-spherical particles have a minor dimension, Pₘᵢₙ, and a major dimension, Pₘₐⱼ, and further comprising rotating the aligned non-spherical particles in the x-z plane prior to guiding the aligned non-spherical particles, the rotating causing the non-spherical particles to approach a guiding region with an effective diameter, P_{eff}, where Pₘᵢₙ≦P_{eff}≦Pₘₐⱼ.

21. A device for removing non-spherical particles from ink in an ink jet printer, comprising:
means for aligning the non-spherical particles along their major dimension as the particles flow through an ink flow channel;
means for guiding the aligned non-spherical particles toward a first streamline region arranged to carry particle-rich ink and away from a second streamline region arranged to carry particle-free ink; and
means for directing the particle-rich ink along a first branch of the ink flow channel and directing the particle-free ink along a second branch of the ink flow channel.

22. The device of claim 21, wherein the non-spherical particles have a minor dimension, Pₘᵢₙ, and a major dimension, Pₘₐⱼ, and further comprising means for rotating the aligned non-spherical particles in the x-z plane, the means for rotating disposed between the means for aligning and the means for guiding, the means for rotating causing the non-spherical particles to encounter the means for guiding with an effective diameter, P_{eff}, where Pₘᵢₙ≦P_{eff}≦Pₘₐⱼ.
